(19) United States
(12) Patent Application Publication
(10) Pub. No.: US 2010/0255049 A1
(43) Pub. Date: Oct. 7, 2010

(54) Eco-friendly antibacterial and mildew-inhibited freshness preserving sheet

(76) Inventor: Wei-Yin Chang, Hou Li Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,179

(22) Filed: Apr. 1, 2009

(51) Int. Cl. A01N 25/34; A01P 1/00; A01P 3/00

(52) U.S. Cl. 424/414

(57) ABSTRACT

An eco-friendly, antibacterial and mildew-inhibited freshness preserving sheet containing volatile and high concentration molecules of Ally isothiocyanate is formed by absorbing all ingredients of anti-mold and eco-friendly antibacterial material through a closed fumigation permeation method until saturated. The sheet has a substrate and a jutting text and pattern layer formed by heated embossing with a zinc plate. The embossed sheet is fumigated by a fumigator containing natural anti-mold and antiseptic material to absorb the ingredients of the natural anti-mold and antiseptic material to become a finished product. The natural anti-mold and antiseptic material includes gradients of Ally isothiocyanate 35% by weight, ploysorbate 5% by weight and natural coconut oil 60% by weight.

### BACKGROUND OF THE INVENTION

1. Field of the Invention

The present invention relates to an eco-friendly, antibacterial and mildew-inhibited freshness preserving sheet and particularly to a freshness preserving sheet that includes an ingredient of Ally isothiocyanate of high volatile and high concentration molecules and is formed through a closed fumigation and permeation method to allow the sheet to absorb all anti-mold ingredients until saturated to provide antibacterial, mildew-inhibited and environment friendly characteristics.

2. Description of the Prior Art

To maintain freshness of foods or articles and prevent them from soggy and molded, a conventional approach usually being adopted is disposing a chemical compound contained in a dehydrated sachet or deoxidized sachet. The chemical compound often is hazardous to human body. To remedy this problem, a mildew-inhibited bonding sheet has been developed that is produced by gasifying. For instance, Taiwan patent application No. 94215658 entitled “Mildew-inhibited bonding sheet” discloses such a product. It mainly includes a release paper and a bonding paper. The bonding paper contains an anti-mold compound which is volatile and can be released. Upon removing the release paper the bonding paper can be bonded inside a container. It is easy to use. To prevent it from being incidentally eaten by users, it has to be printed with a “non-eatable” text or pattern to alert user. To prevent the printing ink from dropping, a lacquer layer is coated on the ink layer. Hence it is harmful to environments. Moreover, referring to FIG. 1, the conventional bonding sheet 10 includes a release paper 11 with an adhesive layer 12 located thereon, a bonding paper 13 located on the adhesive layer 12, and a text/pattern layer 14 located on the bonding paper 13, and a lacquer layer 15 on the text/pattern layer 14 to protect the text and pattern without peeling off. The structure is complex and production cost is higher. Hence there are still rooms for improvement.

### SUMMARY OF THE INVENTION

In view of the aforesaid disadvantages occurred to the conventional structure, the present invention aims to provide an eco-friendly freshness preserving sheet formed by directly embossing a text and pattern on a substrate. The sheet goes through a closed fumigation and permeation process to absorb anti-mold ingredients. The sheet thus formed can eliminate the shortcomings of the conventional products.

Therefore the primary object of the invention is to provide an eco-friendly freshness preserving sheet that contains Ally isothiocyanate of high volatile and high concentration molecules and is formed through a closed fumigated permeation method to allow the sheet to absorb all anti-mold ingredients until saturated to provide antibacterial mildew-inhibited and environment friendly characteristics.

Another object of the invention is to eliminate the ink layer and lacquer layer so that the resulting product can be produced at a lower cost and also is more environment friendly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional structure.

FIG. 2 is a schematic view of the process flow of the invention.

FIG. 3 is a sectional view of the invention.

FIG. 4 is a sectional view of another embodiment of the invention.

FIG. 5 is a schematic view of yet another embodiment of the invention.

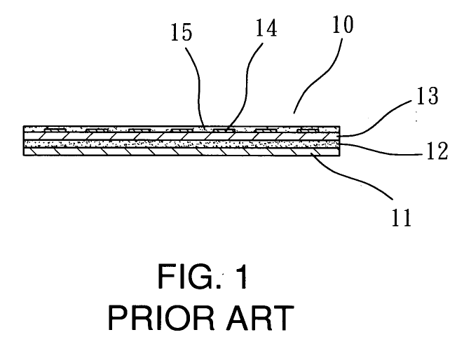

### DESCRIPTION OF THE PREFERRED EMBODIMENTS

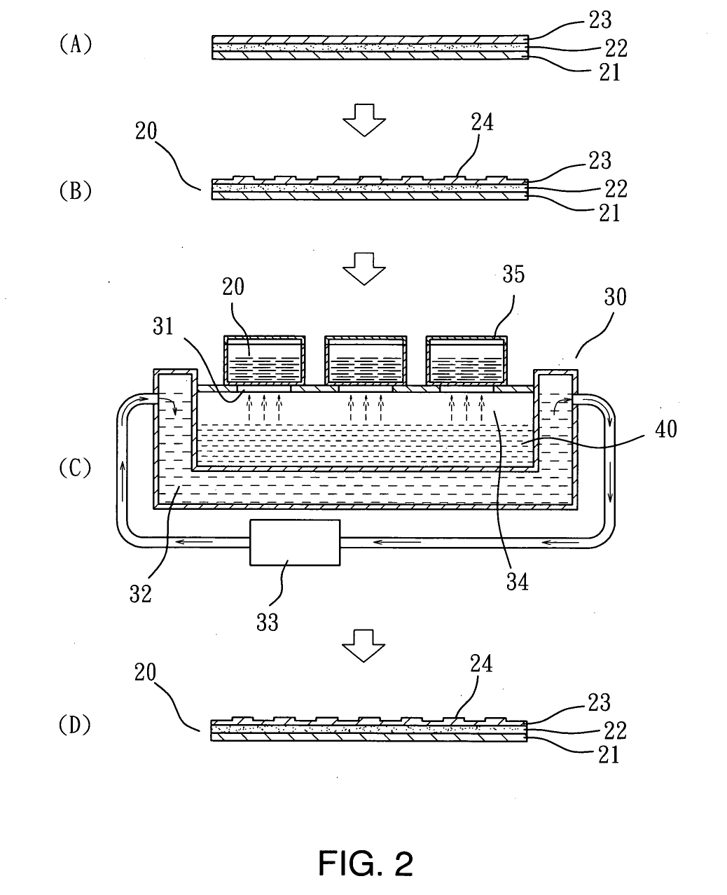

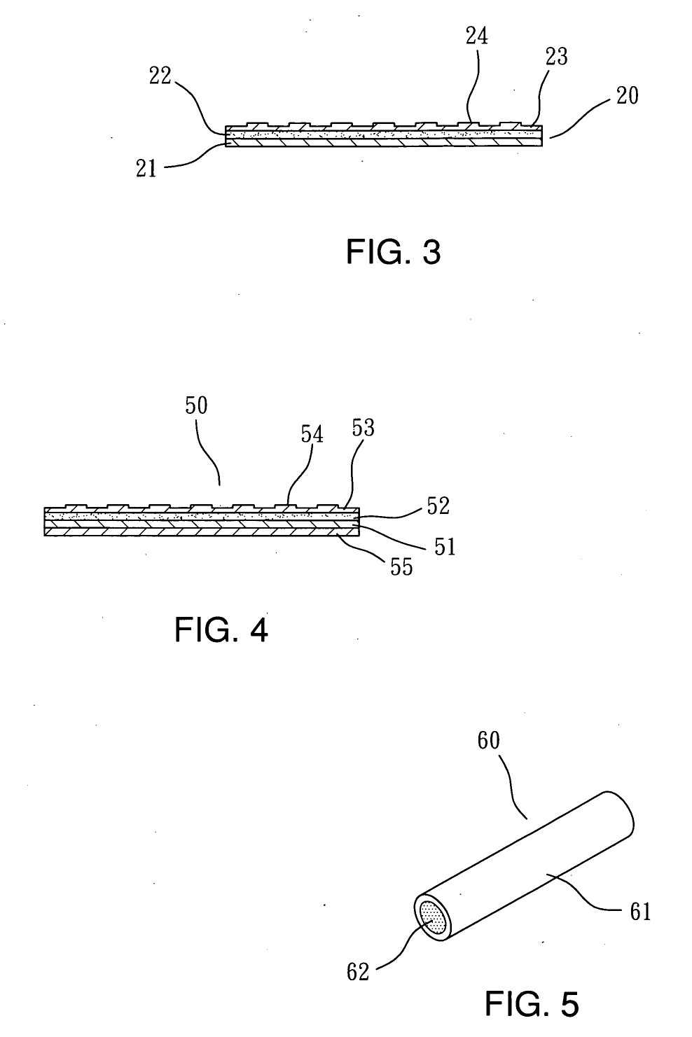

Please referring to FIGS. 2 and 3, the invention mainly includes:

A. A substrate which has a base paper 21 (copperplate printing paper) coated with a layer of solvent-free adhesive 22 and a layer aluminum-sputtered PET layer 23 on the solvent-free adhesive 22;

B. Heated embossing process: the substrate coated with the aluminum-sputtered PET layer 23 goes through a heated embossing process with a zinc plate to form a jutting text and pattern payer 24 to become a sheet 20;

C. Fumigation and permeation process: the sheet 20 is placed in a fumigation cabinet 35 which is positioned above apertures 31 of a fumigator 30. The fumigator 30 is surrounded by a heated water tank 32 which is heated by a heater 33 to maintain water contained in the water tank at a temperature between 25° C.-50° C. There is a fumigation tank 34 inside the heated water tank 32 to receive a natural anti-mold and antiseptic material 40. The sheet 20 is fumigated for 50 to 70 hours so that it absorbs the ingredients of the natural anti-mold and antiseptic material until saturated. The natural anti-mold and antiseptic raw material 40 mainly includes ingredients of: Ally isothiocyanate 35% by weight, ploysorbate 5% by weight and natural coconut oil 60% by weight. The Ally isothiocyanate is obtained from ingredients of natural cruciferous plants, such as Thioglycosides. It contains a great amount of active chemical substance of isothiocyanates. After being dissolved in water and fermented and purified, the Ally isothiocyanate of a high concentration can be abstracted. It is volatile and has anti-oxidation power, and has a special high-molecular structure with great permeability, and can rapidly penetrate the cell membrane of microbes to destroy their DNA and dissolve protein, therefore can destroy bacteria and molds and provide disinfection effect; and

D. Form sheet-like mildew-inhibited finished product: The antibacterial freshness preserving sheet 20 is formed that also provides environment friendly and mildew-inhibited effect.

The structure of the invention previously discussed has the text and pattern directly embossed onto the substrate without the ink layer and protective lacquer layer. The ingredients of natural cruciferous plants can be dissolved through fermentation and abstracted. The anti-mold and antiseptic substances contained inside can be absorbed by the sheet until saturated. As a result, the mildew-inhibited and antiseptic effect can be maintained for a prolonged period.

In addition, a disinfection material may be added to the natural anti-mold and antiseptic material to form a composition as follow: the natural anti-mold and antiseptic material 40 is 70% by weight, ploysorbate 5% by weight and disinfection material 25% by weight. The disinfection material also is abstracted from natural plants, and its composition is Citral 80% and Mycene 20%.

Refer to FIG. 4 for another embodiment of the invention. It has a sheet 50 consisting of a substrate made of copperplate paper 51, a solvent-free release adhesive film 55 formed on a lower side and a solvent-free adhesive 52 formed on an upper side, and an aluminum-sputtered PET layer 53 formed on the top. The aluminum-sputtered PET layer 53 is embossed under heat with a zinc plate to form a jutting text and pattern layer 54. The heated embossing process can dispel moisture from the substrate. The sheet 50 thus formed has a greater thickness. Hence the sheet 50 and solvent-free adhesive 52 can absorb a greater amount of anti-mold material during the fumigation and permeation process. As a result, the antibacterial and mildew-inhibited effect can be enhanced and maintained for a longer period.

Refer to FIG. 5 for yet another embodiment of the invention. The substrate is an insulation layer 61 to encase a cotton layer 62 and is formed in a rod 60. The cotton layer can absorb the natural anti-mold and antiseptic material during the fumigation and permeation process. Thus a mildew-inhibited rod can be formed.

As a conclusion, the eco-friendly, antibacterial and mildew-inhibited freshness preserving sheet according to the invention provides many benefits, such as environment friendly and containing natural ingredients, enhanced antibacterial and mildew-inhibited effect, and extended freshness preserving period. It offers a significant improvement over the conventional products.

I claim:

1. An eco-friendly, antibacterial and mildew-inhibited freshness preserving sheet, comprising a substrate which is embossed under heat with a zinc plate to form a text and pattern layer and proceeded through a fumigation and permeation process in a fumigator containing natural anti-mold and antiseptic material such that the sheet absorbs ingredients of the natural anti-mold and antiseptic raw material, wherein:
the natural anti-mold and antiseptic material consists of Ally isothiocyanate 35% by weight, ploysorbate 5% by weight and natural coconut oil 60% by weight.

2. The eco-friendly, antibacterial and mildew-inhibited freshness preserving sheet of claim 1, wherein the sheet is produced through a process including the steps of:
coating a solvent-free adhesive layer on a base paper and forming an aluminum-sputtered PET layer on the solvent-free adhesive layer;
embossing the aluminum-sputtered PET layer under heat with the zinc plate to form the jutting text and patterned layer;
placing the sheet in a fumigation cabinet and placing the fumigation cabinet above apertures formed on the fumigator surrounded by a heated water tank heated by a heater to maintain the water tank at a temperature between 25° C. and 50° C., the heated water tank having a steam tank inside to receive the natural anti-mold and antiseptic material to allow the sheet to be fumigated and absorb the natural anti-mold and antiseptic material until saturated; and
forming finished products of the eco-friendly, antibacterial and mildew-inhibited freshness preserving sheet.

3. The eco-friendly, antibacterial and mildew-inhibited freshness preserving sheet of claim 1, wherein the Ally isothiocyanate contains ingredients of natural cruciferous plants including Thioglycosides which has an active chemical substance of isothiocyanates, and is abstracted after processes of dissolving in water, fermenting and purification to form the Ally isothiocyanate of a high concentration.

4. The eco-friendly, antibacterial and mildew-inhibited freshness preserving sheet of claim 1 or 2, wherein the natural anti-mold and antiseptic material further includes disinfection material in a composition of 70% by weight for the natural anti-mold and antiseptic material, 5% by weight for the ploysorbate and 25% by weight for the disinfection material.

5. The eco-friendly, antibacterial and mildew-inhibited freshness preserving sheet of claim 4, wherein the disinfection material contains ingredients of Citral 80% by weight and Mycent 20% by weight.

6. The eco-friendly, antibacterial and mildew-inhibited freshness preserving sheet of claim 2, wherein the base paper is copperplate paper.

7. The eco-friendly, antibacterial and mildew-inhibited freshness preserving sheet of claim 2, wherein the base paper has a lower side bonding to a solvent-free release adhesive film.
